(19) United States
(12) Patent Application Publication
(10) Pub. No.: US 2007/0144675 A1
(43) Pub. Date: Jun. 28, 2007

(54) Indelible marking of labels

(75) Inventors: John Darcy Bradley, Feilding (NZ); Michael Eliot Voss, Marton (NZ)

Correspondence Address: YOUNG & THOMPSON, 745 SOUTH 23RD STREET, 2ND FLOOR, ARLINGTON, VA, 22202, US

(73) Assignee: LEYHATTON INNOVATIONS LIMITED, Feilding (NZ)

(21) Appl. No.: 10/575,874

(22) PCT Filed: Oct. 15, 2004
(86) PCT No.: PCT/NZ04/00258

§ 371 Date: Apr. 14, 2006

(30) Foreign Application Priority Data
Oct. 17, 2003 (NZ) 528993

(51) Int. Cl. B65C 9/46

(52) U.S. Cl. 156/387

(57) ABSTRACT

A method of indelibly marking a label (10) which includes a substrate (11) (which is transparent or translucent) and an adhesive layer (12). The method includes applying a marking (14) to the adhesive layer (12) such that the marking is visible through the substrate. The marking (14) can include part thereof in a mirror or reverse image of that which is to be visible through the substrate. The marking can be applied by ink-jet, hot-wax or laser marking (13).

### BACKGROUND TO THE INVENTION

This invention relates to a method of indelibly marking labels and labels resulting from such a method.

The marking of labels on a just-in-time basis is known. This is something which may be required in a wide variety of industries. Thus, for example, in the meat processing industry a label might be printed with pertinent information concerning meat having been or about to be packed into a package. The label may then be applied to the package by way of the label having a self-adhesive coating. However, there are many other applications where a label is printed and applied to an article or package during the manufacture or packaging process.

The marking of the label can be carried out by different means. For example, laser marking of labels on a just-in-time basis is known. The printing medium can be a multi-layer foil on which printed text, numbers, bar codes and the like can be marked by laser marking. Therefore, even with laser marking it is possible to print a label and apply it to an article in a fast and accurate manner during the manufacturing and/or packaging process.

There are, however, situations where tamper-proof or tamper-evident marking of an article is required. In such situations the marking must be incapable of being altered i.e. tampered with. Furthermore, tamper-proof requirements may necessitate that the label cannot be removed for say reuse in a fraudulent manner. Known labels generally do not fulfil the dual functions of indelible marking and being tamper-proof.

For example, in the meat processing industry it is desired that once meat is packed and the package labelled it is not possible to alter the labelling or, indeed, reuse the label. Furthermore, it is required that the package cannot be opened without it being readily evident visually that the package has been opened or tampered with.

In these known arrangements the marking is applied to the surface of the label which is outermost, i.e. the visible surface, when the label is in place on an article, packaging, carton et.

### SUMMARY OF THE INVENTION

It is an object of the present invention to provide a process of indelible marking of a label, the label being of a type that can be adhered to an article to be labelled.

It is a further object of the present invention to provide a tamper-proof or tamper-evident indelible label where markings on the label cannot be altered without removal of the label from an article to which it has been applied.

Broadly according to one aspect of the present invention there is provided a method of indelibly marking a label which includes a substrate and an adhesive layer the method characterised in that marking of the label is applied to the adhesive layer of the label with the resultant marking being visible through the substrate.

In a preferred embodiment the marking is achieved by ink-jet or laser marking.

According to a second broad aspect of the invention there is provided a label formed by a clear or transparent substrate to one surface of which is applied an adhesive layer, marking applied to the adhesive layer being visible through the substrate.

In the preferred form of the invention the label is in the form of a tape.

The adhesive layer can be a rubber based adhesive of a self-adhesive type. A pigment or additive to assistance or effect the marking can be included in the adhesive layer. In the preferred form of the invention a single homogenous layer of adhesive is applied directly to the substrate.

According to the invention at least part of the marking in the adhesive layer is formed as a mirror or reverse image of what is required to be visible and readable through the substrate. In preferred forms of the invention the marking is achieved by laser marking with a vector based green light laser or CO₂ based laser.

### BRIEF DESCRIPTION OF THE DRAWING

In the following more detailed description of a preferred embodiment of the invention, reference will be made to the accompanying drawing in which:

FIG. 1 is a schematic illustration of a label in the form of an adhesive tape to which marking is applied by laser marking in an adhesive layer of the label, and

FIG. 2 is a plan view of the adhesive side of a label on which indicia has been applied by ink-jet or hot-wax printing.

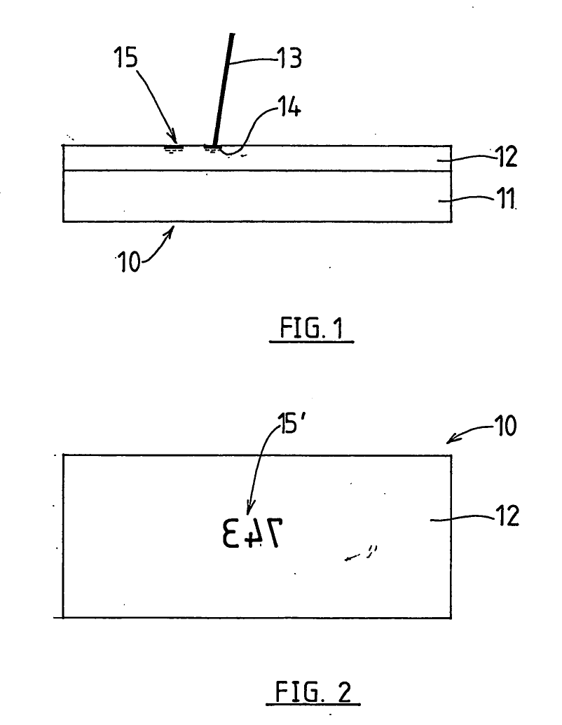

### DESCRIPTION OF A PREFERRED EMBODIMENT OF THE INVENTION

In its broadest application, the present invention relates to marking of a label irrespective of the shape and configuration of the label. However, according to a preferred embodiment of the-invention, the label is in the form of a tape. This, however, is by way of illustration only and is not meant as a limitation of the invention solely to marking of a label in the form of a tape.

As shown in the drawing the tape 10 consists of a substrate 11 and on one surface thereof is an adhesive layer 12. The adhesive layer 12 is preferably a rubber based adhesive of a self-adhesive type. It is in the form of a single homogeneous layer applied directly to the tape substrate 11. In a preferred form of the invention the adhesive layer includes a pigment or additive of a suitable type to effect or enhance the marking in the adhesive layer.

The tape substrate 11 can be of any suitable transparent or translucent material. in the preferred form of the invention the substrate 11 is formed from polypropylene.

According to the present invention, the marking is applied to the tape 10 in the adhesive layer 12. Thus, according to one embodiment of the present invention, a narrow band intense beam 13 of light from a laser source is directed onto the layer 12. The intensity of the light beam 13 causes the near transparent adhesive and pigment/additive layer 12 to darken in the localised area 14 of the laser beam to leave a permanent marking 15. The laser can be a green light laser i.e. it is in the visible wavelength band or a CO₂ based laser in the infrared band e.g. 10.64 micrometre wavelength band.

According to another form of the invention ink-jet marking can be employed. The ink-jet can be applied directly to the adhesive layer. In one form of the invention this may be a hot-wax which provides the advantage that the marking dries instantly thereby enabling the tape/label to be applied immediately after marking has taken place.

The laser marked impression 15 in the adhesive layer 12 is, therefore, visible through the clear or translucent substrate 11. The marking or at least a part thereof is thus applied or formed as a mirror or reverse image of what is required to be visible and readable through the clear substrate 11. Generally this reverse marking will not be required for a marking which is symmetrical e.g. a logo.

The scanning of the laser enables the printing of text, images, bar codes, graphics and other indicia over the entire surface area of the tape with the exception of the edges.

According to one form of the present invention marking of the tape 10 occurs during relative movement between the laser source and the tape 10. In one form of the invention the laser source is retained in one location and the tape 10 is moved past the laser beam but the alternative is equally useable i.e. the laser beams move and the tape is stationery.

The laser marked tape, according to the present invention, has particular application in the meat processing industry where the tape can be used for the labelling of meat containing packages or more preferably can provide the dual function of labelling and sealing of the packages. Thus, the adhesive tape 10 can be marked “just-in-time” with markings, text, alpha/numeric indicia and other graphic markings as may be required e.g. official seals, logos, code lettering/numerals, content/weight information and the like.

In one form of the tape there can be provided weakened portions or areas in the tape such that once the tape has been applied any attempt to remove the tape will result in the integrity of the tape being lost. This is a known art with say security labels, packaging tapes etc. For example, a series of cuts can be made in the tape but other forms of providing a weakened line, area or portion will be apparent to the skilled addressee. This will, therefore, in part, render the sealing of the package tamper-proof because it will be readily evident if the tape has been removed and reapplied.

Also because the marking is in the adhesive layer the marking is not open to tampering. To gain access to the marking the tape would need to be removed and any reapplication would likely be readily visible. In any event it is believed that it would be difficult, if not impossible, to tamper with the marking in the adhesive layer without the tampering being visibly evident even when the marking is viewed through the substrate.

Furthermore, the transparent nature of the plastic substrate 11 can result in enhancement of the contrast between the marking and the background colour, which due to the transparent nature of the tape, will be the colour of the packaging to which the tape is applied. In the meat processing industry the packaging will generally be wood fibreboard based cartons.

The present invention provides clear sharp printing. While the marking can be achieved by inkjet type printing it is believed that laser printing provides an advantage over traditional ink jet type printing, which does not provide an entirely clear image and it is achieved at a cost based on time and materials. Also, the problem that can arise with ink jet printing where solvent can react with the adhesive to thereby lead to unclear image, does not occur.

The foregoing description has not disclosed in detail the types of pigment which can be present in the adhesive layer because the types and selection of pigment is within the knowledge of the skilled addressee.

It will be evident to those skilled in the art that the foregoing description is in respect of preferred embodiments of the invention but that modifications to the invention will be possible yet still be within the scope of the invention.

1-23. (canceled)

24. A method of indelibly marking a label which includes a substrate and an adhesive layer the method characterised in that marking of the label is applied to the adhesive layer of the label with the resultant marking being visible through the substrate.

25. The method as claimed in claim 24 wherein the marking is applied by laser marking.

26. The method as claimed in claim 24 wherein the marking is applied by ink-jet marking.

27. The method as claimed in claim 25 wherein the laser marking is achieved by using a green light laser or CO₂ based laser.

28. The method as claimed in claim 25 wherein the adhesive layer includes a pigment or additive.

29. The method as claimed in claim 26 wherein the marking is by hot-wax ink-jet printing.

30. The method as claimed in claim 24 wherein at least part of the marking is applied in a mirror or reverse image of that which is to be visible and readable through the substrate.

31. The method as claimed in claim 25 wherein marking occurs during relative movement between the label and means for applying the marking.

32. The method as claimed in claim 24 wherein the marking applies one or more of text, alpha/numeric indicia, official seals, logos and graphical representations.

33. A label formed by a clear or transparent substrate to one surface of which is applied an adhesive layer, marking applied to the adhesive layer being visible through the substrate, said substrate being transparent or translucent.

34. A label as claimed in claim 33 wherein the label is in the form of a tape.

35. A label as claimed in claim 34 wherein the adhesive layer is a rubber based adhesive.

36. A label as claimed in claim 33 wherein a pigment is included in the adhesive layer.

37. A label as claimed in claim 33 wherein the substrate is transparent or translucent and formed from polypropylene material.

38. A label as claimed in claims 33 wherein the marking is a laser marking.

39. A label as claimed in claims 38 wherein the marking is a laser marking resulting from use of a vector based green light laser or CO₂ based laser.

40. A label as claimed in claim 33 wherein the marking is effected by ink-jet printing.

41. A label as claimed in claim 40 wherein the ink-jet printing is a hot-wax process.

42. A label as claimed in claim 33 wherein a pigment or adhesive is included in the adhesive layer.

43. A label as claimed in claim 33 wherein the label further includes one or more weakened portions or areas.
